(19) United States
(12) Patent Application Publication
(10) Pub. No.: US 2010/0257127 A1
(43) Pub. Date: Oct. 7, 2010

(54) Modular, folder based approach for semi-automated document classification

(76) Inventor: Stephen Patrick Owens, Norwich, CT (US)

Correspondence Address: Attorney Bruce Tedeschi;Rakosky, Haviland & Tedeschi, PC, PO Box 1190, New London, CT, 06320, US

(21) Appl. No.: 12/229,661

(22) Filed: Aug. 26, 2008

Related U.S. Application Data
(60) Provisional application No. 60/966,150, filed on Aug. 27, 2007.

(51) Int. Cl. G06F 15/18

(52) U.S. Cl. 706/12

(57) ABSTRACT

The Modular, Folder Based Approach for Semi-Automated Document Classification is a systematic approach to implementing a divide and conquer strategy which leverages the power of known automated document classification techniques and organizes the use of standard software techniques into a system which is easy to configure, and deploy.

### CROSS-REFERENCE TO RELATED APPLICATIONS

This application claims the benefit of priority from U.S. Provisional Patent Application Ser. No. 60/966,150 filed Aug. 27, 2007, the disclosure of which is incorporated by reference herein it its entirety.

### BACKGROUND OF THE INVENTION

For services in which documents need to be categorized so that they can be assigned to appropriate subject matter experts for further scrutiny much time is wasted by the subject matter expert while reviewing irrelevant documents that have little to do with the category of documents to be reviewed. Unfortunately a person untrained in the subject matter category (such as an administrative assistant) has a difficult time scrutinizing the document in order to assign it for review by the appropriate subject matter expert.

There is a great deal of academic literature surrounding the use of various automated document classification methods such as Support Vector Machines, and naïve Bayesian systems. There have been very few successes in utilizing this knowledge to provide practical systems for document classification that are easily configured, and understandable to the untrained user.

One exception to this has been the application of the naive Bayesian classification system to the purpose of categorizing e-mail as either SPAM or not SPAM. Naive Bayesian classification systems are very popular among spam filters, because they are very fast and simple for both training and testing: it has optimal training and testing time in the 00 sense (proportional to read through the examples), simplicity to learn from new examples and the ability to modify an existing model.

The use of naive Bayesian classification systems has been largely restricted to limited domains because ordinarily these systems treat the category structure as flat. A drawback of treating the category structure as flat is that the number of training examples for individual classes may be relatively small. However, quite frequently, when dealing with a large number of categories, these categories form a hierarchical structure. For example patent documents, web catalogs, and employee resumes.

By using the divide and conquer approach to solving classification problems at each branch, it is possible to circumvent the limitations inherent in classification systems such as the naïve Bayesian classification system by separating document classes into hierarchies which separate documents into fewer classes with more examples at higher levels, and fewer classes at lower levels.

What is needed currently in the industry is a systematic approach to implementing this divide and conquer strategy which is easy to configure, and deploy, works in a wide range of platforms by leveraging standard platform tools and techniques to the greatest extent possible, and is easy to train personnel to use because it takes advantage of human/machine interface metaphors that these personnel work with on a regular basis.

The approach should to the greatest extent possible be modular, so that individual modules can be reconfigured to support changes to the document classification ontology without requiring significant retraining of the entire network.

The approach should make it easy to set up a systematic feedback loop whereby human examination of documents can be incorporated into the process and allow the process to learn from its mistakes.

The approach should support more than a binary classification of documents and should enable software systems to be developed that can leverage naïve Bayesian classification, hierarchical Bayesian classification, Support Vector Machines and other such document categorization tools in a fairly interchangeable way.

In order to provide an unambiguous technical terminology for describing the invention disclosed within this specification the following definitions are provided:

Core Entity—within this specification the term applies to the use of the Modular, Folder Based Approach for Semi-Automated Document Classification within a single node within a hierarchical ontology of document categories. The approach allows several independent core modules to be configured so that they interoperate without knowledge of each other to produce a document classification system that supports an arbitrarily deep ontology of document categories. The bulk of the Detailed Description of the Invention will be used to describe the precise nature of a Core Entity. The remainder of the Detailed Description of the Invention will show how several Core Entities can be configured so that they work in a nearly-autonomous manner to meet the objectives of the invention.

Configuration Information—a set of information related to program or software settings which can be associated with or stored in a folder that exists as part of a Core Module. Configuration information can include, for example, the location of the various folders that participate in a Core Module.

Data Set—a set of information which is generated or used by the software components of a Core Module that can be associated with or stored in a folder that exists as part of a Core Module.

Folder—An organizational unit, or container, used to organize folders and files into a hierarchical structure. Folders contain or utilize bookkeeping information about folders and files that are, figuratively speaking, beneath them in the hierarchy. Computer manuals often describe directories and file structures in terms of an inverted tree. The files and folders at any level are contained in the directory above them. Commonly known synonyms for the term Folder are Directory, and Cabinet. Within the software industry, the term directory is often used interchangeably with the term folder. With respect to this specification, folders need not reside on the same computer, and can actually be located in different computer systems or networks. Each folder has a unique name or other identifier such as an object ID or universal resource locator which allows it to be unambiguously distinguished from other folders within the same

Root Folder—the topmost directory in a hierarchy of folders. In some content management systems this is called a cabinet.

Subfolder—A folder that is below another folder in a folder hierarchy.

Parent Folder—A folder that is directly above another folder in a folder hierarchy. A parent folder is parent to all of its subfolders and no other folders.

Folder alias—a link that allows a single folder to be part of multiple locations within the folder hierarchy simultaneously. In the UNIX realm this is known as a symbolic link.

File—A collection of related data or program records stored as a unit with a single name or other unique identifier such as an object id or universal resource locator. These names or identifiers are unique within the folder in which they reside, and in some systems are globally unique across the entire system.

Document—A particular type of file consisting primarily of human readable text, or which is intended for use by programs that render human readable text to some type of media such as computer screen or printed paper.

Folder Monitor—refers to a software program or module which utilizes system or application level processes to respond to changes to a folder. In particular such program or monitor will execute a set of software procedures whenever a new file is added to a particular folder that the directory monitor is watching.

File Format—A particular way to encode information for storage in a file.

Text File—A file that uses a file format that contains only text characters.

File Converter Module—a software module that is able to take files in one format and translate them into another format.

Software Module—within this specification the term refers to any collection of computer instructions that are considered to be a single unit with a clearly defined set of inputs and a clearly defined output.

Software Program—within this specification the term refers to a collection of software modules that work together to perform one or more automated computer processes.

Software/Business Process—A combination of human activity with one or more software programs to perform a particular business function.

Category—A name that identifies a collection of semantically similar documents. In general, for any given pair of documents, there tends to be more semantic overlap between two documents in the same category, than there is between two documents in different categories.

Semantic overlap—the (not necessarily measurable) degree to which two documents share the same set of concepts.

Classification Module—is a particular type of software module that is capable of examining a document (possibly with the help of a file converter module) and assign a list of relative probabilities of likelihood or similar relevance score that the given document is a member of a known list of categories. (e.g. CategoryA: 0.37, CategoryB: 0.33, CategoryC: 0.15 etc.)

### REFERENCES

To be determined.

### BRIEF SUMMARY OF THE INVENTION

The Modular, Folder Based Approach for Semi-Automated Document Classification is a systematic approach to implementing a divide and conquer strategy which leverages the power of known automated document classification techniques and organizes the use of standard software techniques into a system which is easy to configure, and deploy. Using this approach it is possible to build software systems that work in a wide range of platforms by leveraging standard platform tools and techniques to the greatest extent possible. This approach facilitates the development of software that is easy to train personnel to use because the software can take advantage of human/machine interface metaphors that these personnel work with on a regular basis.

The approach is modular in that it uses different modules within its architecture as well as acting as a module in a larger network of instances of the approach. Individual instances of this approach can be reconfigured to support changes to complex document classification ontology without requiring significant retraining of the entire network.

The approach makes it easy to set up a systematic feedback loop whereby human examination of documents can be incorporated into the process and allow the process to learn from its mistakes.

The approach supports more than a binary classification of documents and enables software systems to be developed that leverage naïve Bayesian classification, hierarchical Bayesian classification, Support Vector Machines and other such document categorization tools in a fairly interchangeable way.

This approach essentially describes how to structure individual autonomous modules which can work together without direct communication with each other to create a system which organizes documents placed in logical inbound folders and sort (or route) them to an appropriate category folder, as well as adapting to human feedback to periodically re-train portions of the system to more accurately categorize new documents.

One of the inherent advantages of this invention is the inherent simplicity of the architecture. The architecture of this approach lends itself to rapid implementation of robust, user friendly software systems that can be targeted to a wide range of operating systems and software platforms.

Any organization which has a requirement to review documents that can benefit from some level of automation in the pre-sorting of those documents based on category can benefit from incorporating this approach into its existing business process.

One observation that has been made by a number of people that who deal with document migration is that it is easier (and faster) for a human reviewer to look at a document and determine that it does not belong to a particular category than it is to look at a document and determine the appropriate category that it belongs to. This approach to categorization of documents capitalizes on that observation.

Another advantage to this system is that by incorporating a review and recategorization step in the manner described within the invention, there is a 100% chance that the document will be correctly classified, assuming that the judgment of the human reviewers that participate in the system can be taken as authoritative and correct.

### BRIEF DESCRIPTION OF THE SEVERAL VIEWS OF THE DRAWING

FIG. 1—Shows a static picture of the folder structure used by a core entity. Typically in typical configurations that support symbolic links this structure will exist as a folder hierarchy under a folder named for the part of a category ontology that the core entity represents. In configurations built on systems that do not support the use of symbolic links, the directories and their corresponding role assignments within a particular core entity would be identified in some type of configuration file such as an XML configuration file.

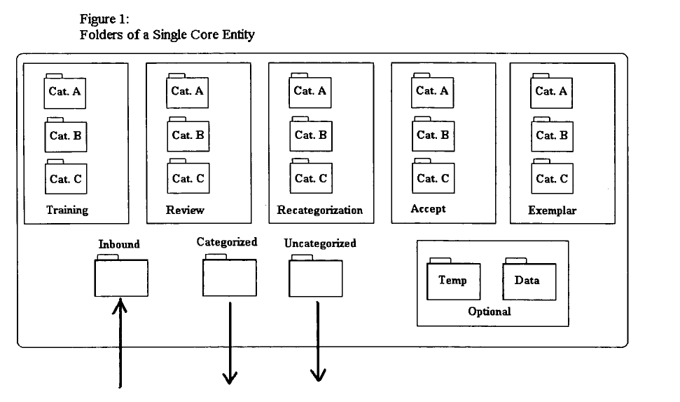

FIG. 2—Shows the relationship between the Training Folders and the Classification Module Training Function. The documents in each category folder are used to form the sample set that the training function uses to “learn” how to identify documents that belong to a particular document category.

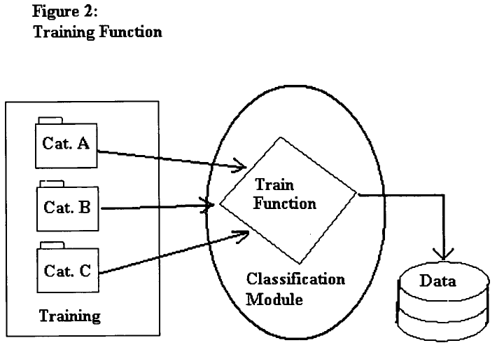

FIG. 3—Shows how the information flows between the Inbound Folder Monitor and the Classification module whenever the Inbound Folder Monitor detects that a new document has been placed in the Inbound Folder. It also shows how the document is moved from the Inbound Folder to the most likely category as indicated by the result vector returned by the Classify Function.

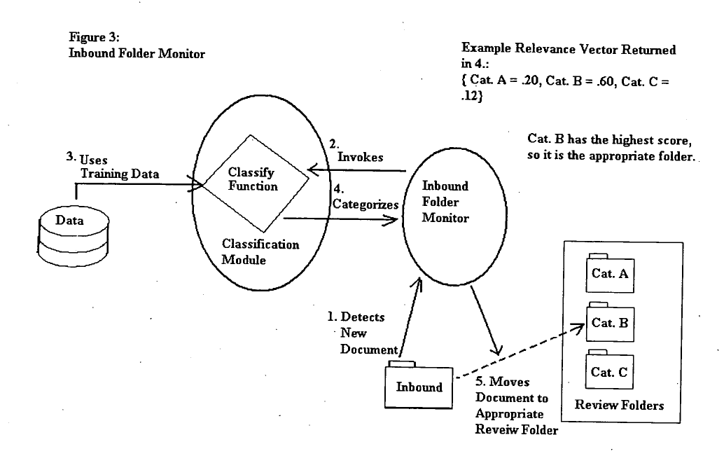

FIG. 4—Shows how a document reviewer (typically a human) that is familiar with the particular category of documents in which the document has been categorized for review. If the document is deemed to be a fit for the category in which it was placed by the Inbound Monitor, then it is moved to an Approved Folder corresponding to the category in which the reviewer found the document in the Review Folder Set.

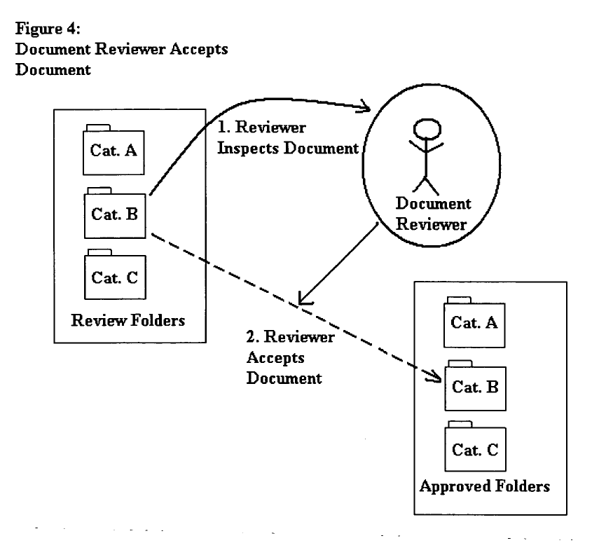

FIG. 5—Shows how a document reviewer (typically a human) that is familiar with the particular category of documents in which the document has been categorized for review. If the document is deemed not to be a fit for the category in which it was placed by the Inbound Monitor, then it is moved to a Recategorization folder corresponding to the category in which the reviewer found the document in the Review Folder Set.

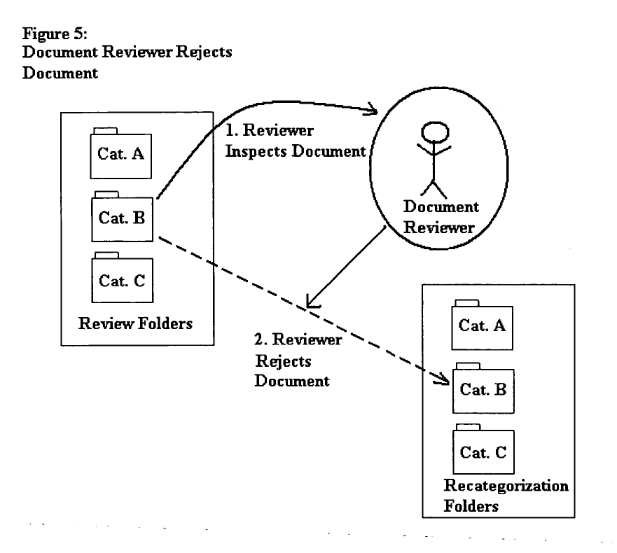

FIG. 6—Shows the flow of information that occurs when the Recategorization Monitor detects that a document has been placed in a Recategorization folder it is configured to monitor. This figure also shows that the folder is moved to the next most likely category for a subsequent review.

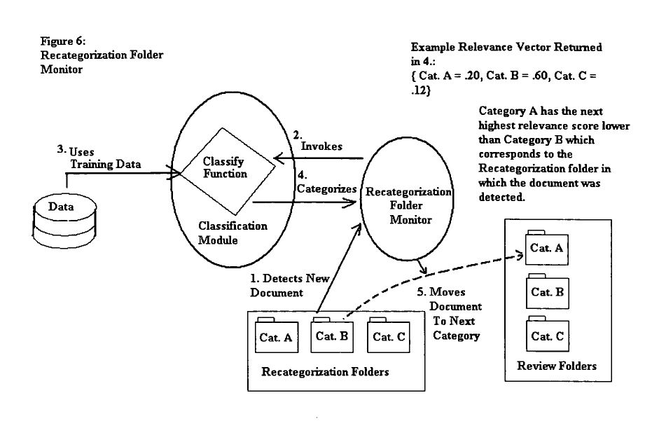

FIG. 7—Shows how two different Core Entities that support an ontology of categories interact with respect to initial categorization. As a document is categorized for review in a core entity associated with a superordinate category, it is immediately picked up by a different core entity associated with a subordinate category. In most configurations cases the Cat x Folder in the superordinate category core entity would be the same physical folder as the Inbound Folder in the subordinate category core entity (either by configuration or by symbolic link). In cases where the two folders are not the same, some automatic means would be deployed (such as a special auto move folder monitor) to cause the documents placed in Cat x Folder to be automatically moved to the Inbound Folder of the subordinate category core entity.

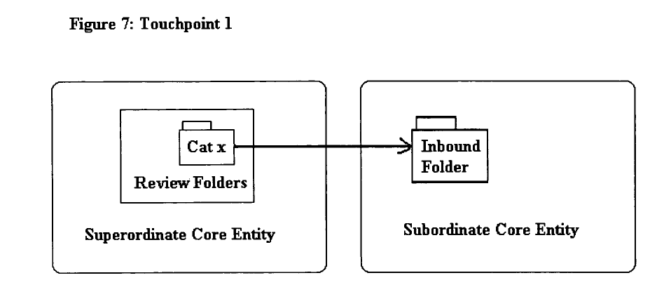

FIG. 8—Shows how two different Core Entities that support an ontology of categories interact with respect to recategorization. As a document in a core entity associated with a subordinate category is rejected from the entire core entity as uncategorizable, it is immediately picked up for recategorization by the superordinate core entity. In most configurations cases the Cat x Folder in the superordinate category core entity would be the same physical folder as the Uncategorized Folder in the subordinate category core entity (either by configuration or by symbolic link). In cases where the two folders are not the same, some automatic means would be deployed (such as a special auto move folder monitor) to cause the documents placed in Uncategorized Folder to be automatically moved to the Cat x Folder of the superordinate category core entity.

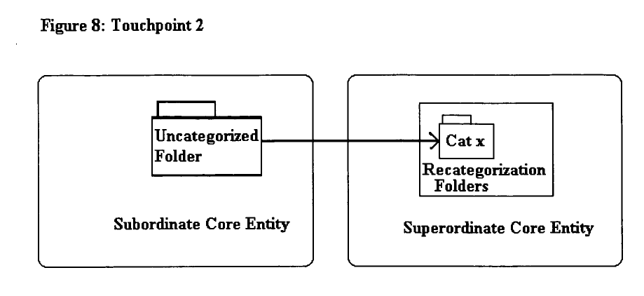

FIG. 9—Shows how two different Core Entities that support an ontology of categories interact with respect to an accepted categorization event. As a document in a core entity associated with a subordinate category is copied to the Categorized folder, it becomes an exemplar document for the superordinate core entity. In most configurations cases the Cat x Folder in the superordinate category core entity would be the same physical folder as the Categorized Folder in the subordinate category core entity (either by configuration or by symbolic link). In cases where the two folders are not the same, some automatic means would be deployed (such as a special auto move folder monitor) to cause the documents placed in Categorized Folder to be automatically moved to the Cat x Folder of the superordinate category core entity.

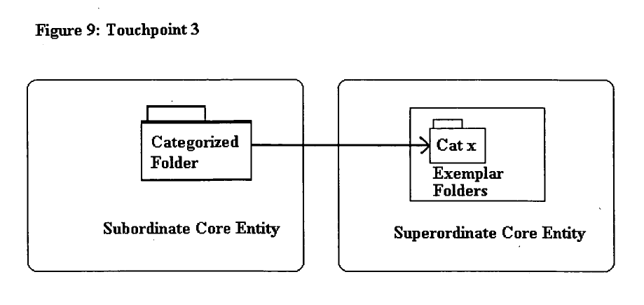

FIG. 10—Shows an example of a categorization ontology. All of the categories shown in rounded rectangles would be associated with core entities. The categories shown in ellipses, would be the final resting place (e.g. Accepted folders) within the superordinate core entities to which they are attached. Human reviewers would be needed to review the documents placed in the Review Folders of the core entities associated with the Engineer and the Technical categories, as well as the Services Category folder of the core entity associated with the Sales category. The review folders associated with the Engineer and Sales categories tied to the Root Category core entity would be the Inbound Folders for the core entities associated with the Engineer and Sales categories in the ontology. This same relationship applies to the core entities associated with the Sales and Technical categories. The arrows indicate the different touch points between the core entities.

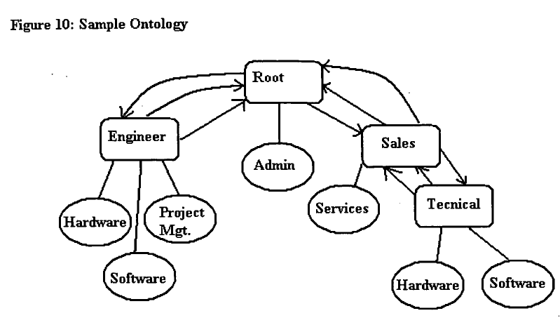

### DETAILED DESCRIPTION OF THE INVENTION

The Modular, Folder Based Approach for Semi-Automated Document Classification consists of a set of and software processes organized around a set of Core Entities. Each core entity consists of a set of folders that are used for specific purposes, software that monitors certain folders, performs categorization on documents placed in monitored folders, and moves those documents to other folders which are associated with a particular list of categories that can be considered to be the child nodes of some particular element of a hierarchical semantic ontology, where they can be utilized by human reviewers, or by other Core Entities which form a network of relatively autonomous units that sort documents into folders that are associated with a particular concept in a complex hierarchical semantic ontology. Each Core entity also includes a basic set of business practices which enable the system to incorporate human feedback to refine the system's ability to place unknown documents in to an appropriate category.

### DESCRIPTION OF A CORE ENTITY

Each core entity includes configuration information, used by the software modules that service the core entity, that identifies the following set of folders:

THE DATA FOLDER: an optional folder where configuration information and data generated by the core entity is stored. Each core entity should use a different data folder. The use of a data folder highly recommended as it leverages the modularity implicit in the folder based system; however it is also possible to use naming conventions or other approaches to bookkeeping to ensure that each core entity uses the entity data designated for it so that the use of a data folder within a core entity is not essential to implementing this approach

THE TRAINING FOLDERS: A set of folders that correspond to the categories that the core entity is configured to consider. Documents that are used as training data for the core entity are placed into the appropriate training folder.

THE REVIEW FOLDERS: A set of folders that correspond to the categories that the core entity is configured to consider. Documents that have been categorized pending human review are placed in these folders. It is possible that a Review Folder may be configured to be the Inbound Folder for a different core entity.

THE APPROVED FOLDERS: A set of folders that correspond to the list of categories that the entity is configured to consider and into which documents that have been reviewed by a human and deemed appropriate to the category are placed.

THE RECATEGORIZATION FOLDERS: A set of folders that correspond to the list of categories that the entity is configured to consider and into which documents that have been rejected by a human reviewer from a particular review folder are placed. Re-categorized documents are placed in recategorization folder that corresponds to the last category from which they are rejected.

THE EXEMPLAR FOLDERS: A set of folders that correspond to the list of categories that the entity is configured to consider and into which a subset of the documents that have been approved may be copied or linked. Note: notionally the Exemplar Folders are different than the Training Folders, however under a limited set of circumstances these folders may actually be one and the same.

THE INBOUND FOLDER: into which uncategorized documents are introduced into the Core Entity. Documents can be placed in the inbound folder in any number of ways including the following:

Uncategorized documents can be placed into the Inbound Folder by a human using a file system manipulation program such as a file browser utility, the save dialog of some document authoring software or custom file manipulation user interfaces that are implemented to supplement the Core Entity software implementation.

Uncategorized documents can be placed into the Inbound Folder by an external automated process such as an e-mail client, or some other software.

Uncategorized documents can be placed into the Inbound Folder by a folder monitor that services a different core entity.

THE CATEGORIZED folder into which a subset of documents which have been placed into a category subfolder of the APPROVED folder are optionally copied

THE UNCATEGORIZED folder into which documents, deemed not to be suitable for inclusion in any category under consideration by the Core entity, are placed.

AN OPTIONAL WORKING FOLDER into which temporary files are placed by some implementations of file converter modules may need to place their output as part of the file conversion process.

Each core entity consists of a common set of software modules that perform specific functions within the approach. These are:

THE CLASSIFICATION MODULE: which examines a document and determines the relative degrees of probability that the document belongs to the set of categories that the core entity is configured to work with? The classification module can use any technique deemed suitable for the particular implementation however it is expected that the most commonly used technique will be some variation of a naive Bayesian categorization method. The classification module minimally has 2 functions: the TRAIN FUNCTION, and the CLASSIFY FUNCTION.

The train function examines the documents stored in the training folders and computes an expectation model which depending on implementation decisions is either persisted to a data set, data file, or maintained in memory. Whenever the train function is about to be executed, all running folder monitors associated with the core entity are notified so that they can safely go into a suspended state.

To ensure robust operation the software components of Core entity implementation should ensure that running folder monitors do not use the training data currently being developed by the train function and that any decisions made by a folder monitor as to where to move a file to, are based upon categorizations made using a consistent set of training data either before or after the training (or retraining) process is complete. This means that while the classification module is being retrained file monitors associated with the Core entity may have to be temporarily suspended.

The classify function utilizes the expectation data generated by the train function, and generates an output vector of relative probabilities for each category associated with the Core entity.

THE INBOUND FOLDER MONITOR: is a software module which monitors the inbound folder and executes a sort activity for each document that is placed in the inbound folder. The sort activity performs the following steps having the prefix “SRT”:

SRT001: The Inbound Folder Monitor locks the file to prevent any other process or thread from modifying, moving, or deleting it and then determines whether the document is an format that the Core entity can recognize, immediately removing documents that are not in a recognizable format, placing them into the Uncategorized Folder and optionally generating some sort of error message or error log entry.

SRT002: The Inbound Folder Monitor invokes the classification module passing the original document reference, identity or stream to the module for analysis. There is a high degree of likelihood that the classification module will only be able to deal with a limited number of file formats; however it is possible to utilize file converters to convert inbound documents into a format suitable for analysis by the classification module. In such cases the Inbound Folder Monitor would be designed and configured to make use of an appropriate file converter software module to transform the document into a format that the classification module understands. Obviously the original document would need to be preserved in such cases, so the system must either make use of a temporary file which the classification module will analyze, or utilize a stream based file converter software module which performs the translation on the fly as it reads the input document and generates an output stream that the classification module is able to read from. Such decisions should be left up to the particular implementer of the Core entity based on the utilities available and/or personal preference.

SRT003: The Inbound Folder Monitor takes the output vector of the classification module which contains a relative relevance score for each category under consideration by the Core entity, and selects the category associated with the highest relevance score. Some tie breaker heuristic will be used so that in the case where two or more relevance scores are identical, the selection of the appropriate category is completely deterministic (for example selecting the category that has the lowest lexicographic value, e.g. the Apples category gets priority over the Blueberries category because A comes before B in the English alphabet)

SRT004: The Inbound Folder Monitor moves the original document thus analyzed into the Review Folder associated with the selected category and unlocks the file and optionally generates an event to the system which could trigger other document management processes such as a workflow in order to prompt a human to review the file thus placed. Alternatively, a Review Folder may also act as the Inbound Folder for a different Core entity, thus enabling a cascading downward trickling of documents from a place high in the semantic ontology down into a leaf of the semantic ontology.

THE DOCUMENT REVIEWER: the document reviewer if utilized by a particular core entity for some or all of the categories it is configured to consider is one or more humans which look at the set of files in one or more Review Folders, and determines if they have been appropriately categorized.

Upon determining that a document is in fact in the appropriate category, the Document Reviewer causes the system to move the document into the Approved Folder that corresponds to the correct category.

Upon determining that a document is not properly categorized, the Document Reviewer causes the system to move the document into the Recategorization Folder that corresponds to the category associated with the Review Folder into which the document was found.

It should be noted that an alternative implementation might also allow savvy Document Reviewers the option of placing the document directly into the Approved folder corresponding to the category they believe the document belongs in. However such an implementation should also include the basic review, reject, recategorize methodology described here.

The implementer of the system may implement the system in such a way as to have the Document Reviewer simply use the file system utilities provided by the platform to move the document into the appropriate location, or they might build a custom utility that allows the reviewer to invoke some sort of accept command, from within a convenient user interface such as an add-in menu item integrated into the document view software, which performs the move behind the scenes.

THE TRAINING MONITOR: this is a software monitor that keeps track of documents as they progress through the approval process, folder monitors can register and update documents that they manipulate with the training monitor using event message architecture, or an API call. The training monitor responds to two three events: the Detected Event, the Moved Event, the Removed Event and the Accepted Event. The primary function of the Training Monitor is to decide which, if any, of the documents that are accepted (e.g. identified as fitting within a category) should be copied into the Exemplar Folders for the purpose of updating the Training Folders at regularly scheduled intervals.

The Detected Event occurs when a document is placed into a Recategorization Folder. Upon receiving notification that this event has occurred, the Training Monitor will create a record of the document identity and/or the current location of the document file. (Note: This event is optional)

The Moved Event occurs when a document is moved to another folder within the Core entities domain (e.g. one of the folders the Core Entity is configured to know about). Upon receiving notification that this event has occurred, the Training Monitor updates the record to reflect the document's new location within the Core Entity. (Note: This event is optional)

The Removed Event occurs when a document is moved to a folder that is not within the Core Entities domain (e.g. a folder that the Core Entity is not configured to know about). Upon receiving notification that this event has occurred, the Training Monitor will delete the record associated with the document thus removed. (Note: This event is optional)

The Accepted Event occurs when a document is moved into one of the Accepted Folders thus indicating to the system that the document has been appropriately categorized. Upon receiving notification that this event has occurred, the Training Monitor will execute decision logic to decide whether to copy the accepted document into an exemplar folder that corresponds to the category into which the document has been accepted. The decision logic used to make the decision to copy or not to copy is outside the scope of this invention and may be as simple as take every 1 out of N previously recategorized documents that have been accepted, or may involve more advanced heuristics. (Note: This event is pretty much central to the purpose of the Training Monitor and is not optional)

THE TRAINING SCHEDULER: this is either a human driven or automatically scheduled process by which the periodic execution of a training activity is invoked.

The training activity performs the following steps having the prefix “TM”:

TM001: the scheduler causes all monitors that service the core entity to suspend their activity.

TM002: the scheduler copies some or all of the files from the Exemplar Folders into the corresponding category folders.

TM003: the scheduler copies some or all of the files from the Exemplar Folders into the Categorized Folder.

TM004: the scheduler empties the Exemplar Folders. (Note: This step is optional)

TM005: the scheduler reactivates the suspended monitors.

THE RECATEGORIZATION FOLDER MONITOR: this monitors the recategorization folders and whenever a document is placed into one of the Recategorization Folders executes a recategorization activity for each file thus placed. The recategorization activity performs the following steps having the prefix “RECAT”:

RECAT001: The Recategorization Folder Monitor locks the file to prevent any other process or thread from modifying, moving, or deleting it and then determines whether the document is in a format that the Core entity can recognize, immediately removing documents that are not in a recognizable format, placing them into the Uncategorized Folder and optionally generating some sort of error message or error log entry.

RECAT002: The Recategorization Folder Monitor invokes the classification module passing the original document reference, identity or stream to the module for analysis. In the same way that file converter software modules are able to be used in conjunction with the Inbound Folder Monitor during step SRT001 of the sort activity, file converter modules may also be used in this step to transform files into a format suitable for consumption by the Classification Module.

RECAT003: The Recategorization Folder Monitor takes the output vector of the classification module which contains a relative relevance score for each category under consideration by the Core entity, and selects the category associated with the highest relevance score that is lower than the relevance score associated with the category that the document was most recently rejected from (this can be determined by the folder identity in which the document currently resides). Some tie breaker heuristic will be used so that in the case where two or more relevance scores are identical, the selection of the appropriate category is completely deterministic (for example selecting the category that has the lowest lexicographic value, e.g. the Apples category gets priority over the Blueberries category because A comes before B in the English alphabet)

RECAT004: If the Recategorization Folder Monitor is able to select a folder it moves the original document thus analyzed into the Review Folder that corresponds to the selected-category and unlocks the file. If all categories have been exhausted then the Recategorization Folder Monitor moves the file into the Uncategorized Folder. Note in cascading systems, the Uncategorized Folder may actually be the Review folder of a different Core entity.

### Interconnecting Core Entities to Form a Larger Network

With respect to this invention the term Folder represents a logical collection of files with the assumption that the invention is built upon some type of software infrastructure that can manifest the notion of files and folders as defined in the Background of the Invention section of this specification, or the logical equivalent thereof. The actual infrastructure can vary quite a bit. Some examples include: most modern operating systems, a relational database so constructed that records within the database are used to represent the concept of folders and files, a distributed system such as WEBDAV that organizes information in a structure that uses atomic units of information analogous to files collected into groups analogous to folders.

The main features of such an infrastructure are that it provides low level services for uniquely identifying atomic units of information analogous to files, as well as services for grouping related files into collections analogous to folders.

Other features said infrastructure must provide, are services to support basic file handling operations which include: read the contents of a file in serial fashion, move as well as copy a file from one folder to another, services that allow a particular software module or process to obtain a lock on a file such that no other software module or process concurrently running may modify, move or delete the file without first having the lock released by the locking software module or process.

Additionally the infrastructure must provide some means by which a software module can detect that a file has been added to a folder that the module is instructed to monitor along with enough information to enable that monitoring process to perform the aforementioned file handling services.

The infrastructure must provide some means by which multiple software modules can operate concurrently and independently, with the exception of the aforementioned locking services which are used to synchronize the activity of concurrent software processes or threads with respect to the files that they handle.

Some examples of infrastructures that meet the above stated requirements are: the UNIX Operating System, the Macintosh Operating System, the Windows Operating System (WinNT, 2000, XP, VISTA), the Documentum Content Management System, a set of WEBDAV servers and clients.

A single core entity utilizes a set of software modules that operate together to produce a system that organizes files into folders based upon decisions made by the various modules within the core entity. The assignment of particular roles to these folders is purely a logical convention. It is possible for two core entity instances to be interconnected by assigning different roles to a folder with respect to different entities.

Each core entity is modular in that it has a particular folder which serves the role of providing input to the system, a particular pair of folders which serve the role of providing sinks for output from the system as well as sets of folders that may be considered internal with respect to a particular core entity that serve as either temporary or final storage areas for files handled by the core entity. However any folder that is considered internal with respect to a particular core entity can simultaneously are configured to be used in a different role with respect to a different core entity.

It is by this mechanism that collections of core entities may be configured to utilize a divide and conquer strategy to the problem of organizing documents according to a complex semantic ontology.

Alternatively, in highly decoupled architectures, the touch-points between two core entities might be established by some sort of file transfer protocol rather than actually sharing the same folders.

Example of a Simple Train Function

The following pseudo code shows how a simple classification function might be implemented using a naïve Bayesian method.

This is an original approach to implementing a Naïve Bayesian Classification and is different in some respects to published implementations that the inventor has previously seen in the following ways.

This method stores the probabilities in a table for later use.

This method takes a normalization step at the end of the computation of raw relative logarithmic relevance scores so as to produce a vector that is representative of an actual probability (or probability like) score for each category between 0 and 1.

```
Function GetNextWord (InputFile)
    Read the file one character at a time until a string
    of characters corresponding to a word is found and
    return that string of characters.
    If no more words, return NULL.
End Function
```

```
Function IsGoodWord(w)
    If w is not a stop word, and w matches none of the other
    criteria you wish to use to exclude non-words from the
    set under consideration then return true otherwise return false.
End Function
```

```
Function CountNGrams (InputFile)
    Create Map<String, Number> WCOUNT
    Define len as length of n-gram in words (e.g. 3)
    Define N as a string (or n-gram)
    Define Q as a queue that holds strings.
    Set W = GetNextWord(InputFile)
    While W not NULL
        If IsGoodWord(W) returns true then
            Q.enqueue(W)
            If Q.length > N Then Q.dequeue( )
            Set S = Concatenate(all Words W in Q)
            If exists item I in WCOUNT Map with a key matching
            S then
                Increment I.count
            Else
                Add new Item I with Key(S)
                Set I.count = 1
            End If
        End If
    End While
Return WCOUNT
End Function
```

```
Function EnumerateNGrams(Category, InputFile)
    SET WC = CountNGrams (InputFile)
    For Each Item I in WC
        If Exists Row R in Words Table with Key Matching
        (Category, WC.key) Then
            Increment R.count by WC.value
        Else
            Add Row R to Words Table with Key(Category, WC.key)
            Set R.count = WC.value
        End If
    Next I
End Function
```

```
Function Compute WordTotalsAndProbs( )
    For Each Row WR in Words Table
        If Catalog Table has no rows then
                add a row CTR to Catalog Table
                Set CTR.wordcount = 0
        Else
                Set CTR = Select only row in Catalog Table
        End If
        Set CR = Select Row from Categories Table Where
        CategoryName = WR.category
        If CR not Found then
            Add a row CR to Categories Table
            Set CR.wordcount = 0
        End If
        Increment CR.wordcount by the value of WR.count
        Increment CTR.wordcount by the value of WR.count
    End For
    For Each Row WR in Words Table
          WR.ProbWC = WR.count / CR.wordcount
    End For
End Function
```

```
Function Train(TrainingFolders)
    Delete All Rows From Words Table, Categories Table and Catalog
    Table
    For each Folder CAT in TrainingFolders
        For each File F in CAT
            EnumerateNGrams(CAT.name, F)
        End For
    End For
    ComputeWordTotalsAndProbs( )
End Function
```

Example of a Simple Classify Function

```
Function Classify(InputFile)
    Create Map<String, Number> RESULT
    Set CTR = Select only row in Catalog Table
    Set WC = CountNGrams (InputFile)
    Declare lnScore as Number
    Declare sumScores as Number
    Declare countScores as Number
    Declare meanScores as Number
    Declare probCI as Number
    Set sumScores = 0
    Set countScores = 0
    # Compute the Raw Scores as follows
    For Each Row CR in Categories Table
        Set lnScore = 0
        For Each Item I in WC
            Select Row WR from Words Table having
            Key(CR.name, I.key)
            lnScore += Math.LogNatural(WR.ProbWC)
        Next I
        Set probCI = CR.wordcount / CTR.wordcount
        lnScore += probCI
        sumScores += lnScore
        countScores += 1
        Add new Item R to RESULT with Key(CR.name)
        Set R.value = lnScore
    Next CR
    Set meanScores = sumScores / countScores
    # Normalize the Scores
    For each Item R in RESULT
        Define adjustedScore as Number
        Set adjustedScore = (R.value / meanScores) / countScores
        Set R.value = adjustedScore
    Next R
    Return RESULT
End Function
```

Summary of System Features

With the possible exception of the Classification Module itself, any aspect of the system can be implemented either as a software module, process or as a human actor with access to basic file system functions.

The system can utilize different implementations of the Classification Module in different core entities. Some examples of types of Classification Modules that might be employed are naïve Bayesian, hierarchical Bayesian, and Support Vector Machines.

No system level information needs to be maintained in order for the network of core entities to interoperate. In other words, each core entity only needs to be aware of the files that are currently maintained within the folders associated with that entity, and the state of the monitors associated with the entity. Core entities are entirely self-contained with the possible exception that two core entities may share some of the same physical folders.

The self contained nature of the Core entity architecture lends the entire system quite favorably to a parallel computing architecture.

Optimization Suggestions

Within the description of the operation of a Core Entity there was made mention several times of copying files from one folder to another. One storage optimizing step that could be taken is to utilize file links or shortcuts rather than physical copies of the files in some or all of the steps where files are copied from one folder to another. Note the term copy and the term move are not interchangeable terms.

For storage constrained systems where some or all of the core entities share the same file system, the use of symbolic links to manage the touch-point folders (e.g. Inbound, Uncategorized, and Categorized) may make sense.

For highly decoupled implementations, including systems wherein each Core entity manages its own internal file system (which is a possible option), some sort of file transfer protocol could be used to move files between one core entity and another at the touch-points.

The invention claimed is:

1. A document classification system for classifying text documents into a particular category in a complex ontology comprising a set of entity means which:
(a) use a set of folders, and folder monitoring processes operating on documents to classify them within a subset of the ontology or domain of interest;
(b) use an automated text classification module to make a preliminary classification of documents into a category of interest associated with the entity whereby a classification module is able to use an example set of appropriately classified documents to train itself to classify new documents that match the categories in the entity's domain of interest with a measurable degree of accuracy;
(c) use an external final decision step to determine whether the initial automated classification is appropriate; and
(d) use an iterative process consisting of an automated re-classification step, in conjunction with an external decision step, to either locate the appropriate classification within the domain of interest for the entity, or to reject the document from the entity's domain of interest to be handled by some other process.

2. A document-classification system as claimed in 1 further comprising a training means such that the classification module uses an example set of appropriately classified documents to train itself to classify new documents that match the categories in the entity's domain of interest with a measurable degree of accuracy.

3. A document-classification system as claimed in 2 further comprising a training means such that documents which are initially classified incorrectly, but are subsequently categorized within the domain of interest covered by the entity, become candidates for subsequent training of the classification module.

4. A document-classification system as claimed in 1, 2, or 3 wherein the external final decision step may be executed by a human subject matter expert who either accepts or rejects the preliminary classification made by the automated text classification module.

5. A document-classification system as claimed in 1, 2, or 3 wherein the external final decision step may be executed by a non-human autonomous entity which either accepts or rejects the preliminary classification made by the automated text classification module.

6. A document-classification system as claimed in 5 wherein the autonomous entity is an external computer process.

7. A document-classification system as claimed in 1, 2, or 3 wherein the entity means may exist on the same computer system.

8. A document-classification system as claimed in 1, 2, or 3 wherein the entity means may exist on separate computer systems as implementation needs dictate.

9. A document classification system for classifying text documents into a particular category in a complex ontology comprising a set of interconnected entity means wherein each entity operates independent of all other entities.

10. A document classification system as in claim 9 wherein a set of interconnected entity means operate without central logic control.

11. A document classification system as in claim 9 wherein a set of interconnected entity means operate without the need for a globally accessible data store.

12. A document classification as claimed in 9, 10, or 11 wherein the set of interconnected, but independent, entity is mediated by the use of folder structure means and folder monitoring means.
